(19) United States
(12) Patent Application Publication
(10) Pub. No.: US 2015/0312656 A1
(43) Pub. Date: Oct. 29, 2015

(54) EXTENDED FLUID METER BATTERY LIFE APPARATUS AND METHODS

(71) Applicant: NEXGRID, LLC, Fredericksburg, VA (US)

(72) Inventor: Costa Apostolakis, Locust Grove, VA (US)

(21) Appl. No.: 14/698,807

(22) Filed: Apr. 28, 2015

Related U.S. Application Data
(60) Provisional application No. 61/984,925, filed on Apr. 28, 2014.

(51) Int. Cl. H04Q 9/00; G01F 15/06

(52) U.S. Cl. CPC H04Q 9/00; G01F 15/063; H04Q 2209/40

(57) ABSTRACT

Extended fluid meter battery life apparatus and methods. In an embodiment, the fluid metering device may include a battery; a wireless communications unit powered by the battery; and a monitoring unit configured to monitor fluid usage information to determine whether the fluid usage information meets a predetermined condition. The wireless communications unit may be powered up if the fluid usage information meets the predetermined condition and the fluid usage information may be transmitted using the wireless communications unit.

### RELATED APPLICATION

This application is a non-provisional application of prior pending U.S. Provisional Patent Application Ser. No. 61/984,925, filed Apr. 28, 2015, which is herein incorporated by reference in its entirety.

### BACKGROUND

1. Field

Embodiments of the present invention relate generally to fluid meters. More particularly, embodiments of the present invention relate to apparatus and methods for extending battery life of fluid meters.

2. Description of the Related Art

Utility companies provide fluids (such as water and gas) and electricity to buildings (such as houses and office buildings or subspaces therein). The amount of fluid and electricity provided by a utility company to a building may be measured by flow through metering devices. Electricity is typically constantly supplied at an appreciable rate to a building. This is due to the constant demand for at least some electricity by electric devices within the building (e.g., electric clocks and emergency exit signs). That is, there is typically always an appreciable amount of electric flow activity occurring. Accordingly, an electricity flow meter is typically always metering electric flow at an appreciable rate. In contrast, fluids typically flow to a building more intermittently. For example, when a sink is turned on, water flows to the building until the sink is turned off. Accordingly, a fluid flow meter may capture more intermittent flow.

Conventionally, flow meters were mechanical devices that had to be monitored or “read” by a utility company representative every billing cycle (e.g., monthly) to determine building usage for each billing cycle. As technology has progressed, flow meters using digital technology have been developed. These digital flow meters have advanced to include wireless communications capabilities such that usage information including building usage for a billing cycle can be automatically transmitted from a digital flow meter to a utility company using wireless technology.

Digital flow meters require power to, among other things, transmit usage information via a transmitter. This power requirement is not typically a problem for electricity flow meters, as electricity flow meters have access to a continuous flow of electric power. However, fluid flow meters typically include a battery having a finite battery life. To conserve battery life, a regularly scheduled transmission of usage information via a low power one-way transmitter may be used instead of constant transmission. However such a solution may still not be optimal in terms of preserving battery life and may also be less than optimal in terms of timeliness and accuracy of usage information.

In light of the foregoing and other shortcomings in the art, it is desirable to provide extended fluid meter battery life.

### BRIEF SUMMARY

It is an aspect of the invention to provide extended fluid meter battery life.

It is a further aspect of the invention to provide improved timeliness and accuracy of fluid usage information.

According to an aspect of the invention, a fluid metering device may be provided. The fluid metering device may include a battery; a wireless communications unit powered by the battery; and a monitoring unit configured to monitor fluid usage information to determine whether the fluid usage information meets a predetermined condition. The wireless communications unit may be powered up if the fluid usage information meets the predetermined condition and the fluid usage information may be transmitted using the wireless communications unit.

In an embodiment, the wireless communications unit may be powered down after the transmitting of the fluid usage information.

In an embodiments, the wireless communications unit may be powered down after the transmitting of the fluid usage information after receipt of an acknowledgement of receipt of the transmitted fluid usage information.

In an embodiment, the predetermined condition may be whether a change in fluid usage information meets or exceeds a predetermined threshold.

In an embodiment, the fluid metering device may further include a fluid input; a fluid output; a fluid channel between the fluid input and the fluid output; and a flow measuring unit configured to measure a flow amount of fluid passing through the fluid channel. The fluid usage information may be processed from the flow amount of fluid.

In an embodiment, the fluid metering device may further include a memory and a controller, wherein the controller may be configured to process the flow amount of fluid into the fluid usage information, and wherein the fluid usage information may be stored in the memory.

In an embodiment, the wireless communications unit may be a ZigBee communications unit.

In an embodiment, the battery may be a lithium battery.

In an embodiment, the monitoring may be periodic.

According to an aspect of the invention, a fluid metering method may be provided. The fluid metering method may include monitoring, using a monitoring unit, fluid usage information to determine whether the fluid usage information meets a predetermined condition; and powering up a wireless communications unit powered by a battery if the fluid usage information meets the predetermined condition, and transmitting the fluid usage information using the wireless communications unit.

In an embodiment, the fluid metering method may further include powering down the wireless communications unit after the transmitting of the fluid usage information.

In an embodiment, fluid metering method may further include receiving an acknowledgement of receipt of the transmitted fluid usage information before said powering down of the wireless communications unit.

In an embodiment, the predetermined condition may be whether a change in fluid usage information meets or exceeds a predetermined threshold.

In an embodiment, the fluid metering method may further include receiving fluid in a fluid input, through a fluid channel, and out through a fluid output; and measuring, using a flow measuring unit, a flow amount of the fluid passing through the fluid channel. The fluid usage information may be processed from the flow amount of fluid.

In an embodiment, the fluid metering method may further include processing, using a processor, the flow amount of fluid into the fluid usage information; and storing the fluid usage information in a memory.

In an embodiment, the wireless communications unit may be a ZigBee communications unit.

In an embodiment, the battery may be a lithium battery.

In an embodiment, the metering may be periodic.

According to an aspect of the invention, a fluid metering device may be provided. The fluid metering device may include a fluid input; a fluid output; a fluid channel between the fluid input and the fluid output; a flow measuring unit configured to measure a flow amount of fluid passing through the fluid channel; a battery; a wireless communications unit powered by the battery; and a monitoring unit configured to monitor the flow amount of fluid to determine whether the flow amount of fluid meets or exceeds a predetermined threshold. The wireless communications unit may be powered up if the flow amount of fluid meets or exceeds the predetermined threshold and the flow amount of fluid or fluid usage information may be transmitted using the wireless communications unit.

In an embodiment, the fluid metering device may further include a memory and a controller, wherein the controller may be configured to process the flow amount of fluid into the fluid usage information, and wherein the fluid usage information may be stored in the memory.

The foregoing and other aspects will become apparent from the following detailed description when considered in conjunction with the accompanying drawing figures.

### BRIEF DESCRIPTION OF THE DRAWINGS

FIG. 1 is a schematic representation of a fluid metering device according to an exemplary embodiment of the present invention.

FIG. 2 is a schematic representation of fluid metering method according to an exemplary method of the present invention.

FIG. 3 is a schematic representation of usage information according to an exemplary embodiment of the present invention.

### DETAILED DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

As used in the description of this application, the terms “a”, “an” and “the” may refer to one or more than one of an element (e.g., item or act). Similarly, a particular quantity of an element may be described or shown while the actual quantity of the element may differ. The terms “and” and “or” may be used in the conjunctive or disjunctive sense and will generally be understood to be equivalent to “and/or”. Elements from an embodiment may be combined with elements of another. No element used in the description of this application should be construed as critical or essential to the invention unless explicitly described as such. Further, when an element is described as “connected,” “coupled,” or otherwise linked to another element, it may be directly linked to the other element, or intervening elements may be present.

A combination of hardware and software in a fluid metering device may monitor for fluid flow activity and transmit that fluid flow activity upon actual use thereby saving battery power and improving timeliness of fluid usage information. A monitoring unit may at intervals, determine whether fluid usage information meets a predetermined condition. For example, a monitoring unit may determine whether a change in fluid usage information meets or exceeds a predetermined threshold (e.g., one or more gallons used since last transmission). When the fluid usage information meets the predetermined condition, then a communications unit “wakes up” (or is “powered up”) and broadcasts the usage information. Once fluid usage information is transmitted, an acknowledgement or confirmation may be received by the communications unit that the fluid usage information was in fact received. Thereafter, the communications unit may power down. By only powering the communications unit upon a predetermined usage occurring (as opposed to constantly or periodically), battery life may be extended and timeliness of usage information may be improved. By receiving an acknowledgement that the fluid information was in fact received, accuracy of usage information may be improved.

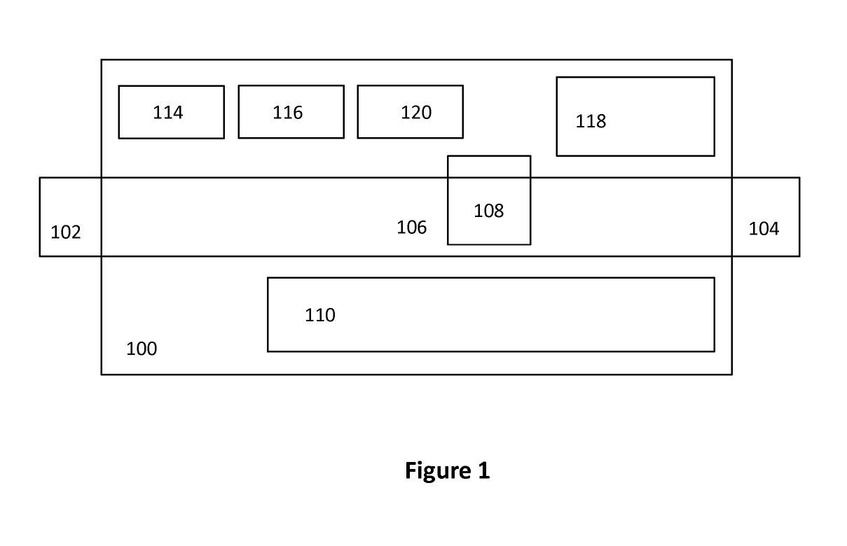

FIG. 1 is a schematic representation of a fluid metering device 100 according to an exemplary embodiment of the present invention. The fluid metering device 100 may include a fluid input 102, a fluid output 104, and a fluid channel 106. The fluid metering device 100 may further include a fluid flow measuring unit 108, a battery 110, a controller 114, and a memory 116. The fluid metering device 100 may further include a wireless communications unit 118, and a monitoring unit 120.

The battery 110 may be a lithium battery, such as a lithium-thionyl chloride cell. The battery 110 may power all or some of the components of the fluid metering device 100. Although a lithium battery 110 has been discussed, the invention is not limited thereto. For example, in an alternative embodiment, an alkaline or zinc battery may be used.

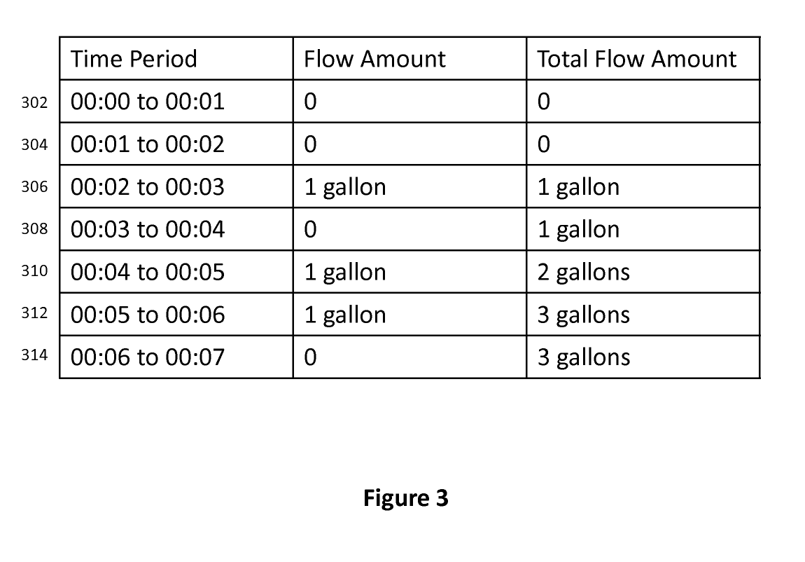

A fluid may be received into the fluid input 102, flow through the fluid channel 106, and out through the fluid output 104. When passing through the fluid channel 106, a flow amount of the fluid may be measured by the fluid flow measuring unit 108. The flow amount of the fluid may be captured from fluid flow measuring unit 108 and may be processed by the controller 114 into fluid usage information. The fluid usage information may be stored in the memory 116 (as described below with reference to FIG. 3), and transmitted from the fluid metering device 100 using the wireless communications unit 118. The transmission may be under the control of the monitoring unit 120 and the controller 114, and may occur upon actual usage. Although the flow amount of the fluid captured by the fluid flow measuring unit 108 is described as being processed by the controller 114 into fluid usage information, stored in the memory 116 and then transmitted by the communications unit 118, the invention is not limited thereto. For example, in an alternative embodiment, a fluid flow amount may serve as the fluid usage information without processing by a processor and may be transmitted by the wireless communications unit 118.

The monitoring unit 120 may monitor the fluid usage information in the memory 116 to determine whether the fluid usage information meets a predetermined condition. If the fluid usage information meets the predetermined condition, the controller 114 may power up the wireless communications unit 118 which may then transmit the fluid usage information. The transmitted fluid usage information may ultimately be received by a utility company. In an embodiment, confirmation may be received by the communications unit 118 that the fluid usage information was in fact received (e.g., by the utility company or an intermediary). If confirmation is not received, the fluid usage information may be resent. After transmission of the fluid usage information, the controller 114 may power down the wireless communications unit 118. In an embodiment, the monitoring unit 120 may periodically check the fluid usage information 116 (instead of constantly monitoring the fluid usage information). That is, the monitoring unit 120 may have a “sleep mode”. By only checking the fluid usage information on a regular interval, and then by only powering up the wireless communications unit the fluid usage information meets the predetermined condition, even more power may be saved. The interval for monitoring may be set, for example, by balancing the need for timelier usage information (a smaller time interval between each check) against the need for greater battery life savings (a larger interval between each check).

The wireless communications unit 118 may be a ZigBee communications unit based on the IEEE 802.15 standard. In the present embodiment, the wireless communications unit 118 may enable two way communications to and from the fluid metering device 100. For example, once fluid usage information is transmitted from the wireless communications unit 118, confirmation may be received by the communications unit 118 that the fluid usage information was in fact received (e.g., by the utility company or an intermediary). Although a ZigBee wireless communications unit 118 has been described, Wi-Fi, Z-Wave, Bluetooth and/or other communications units may be used.

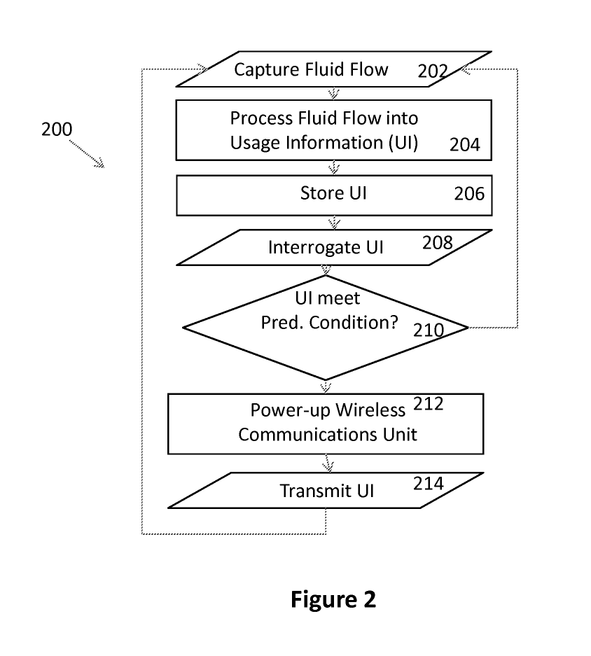

An exemplary operation of the fluid metering device 100 is now described with reference to FIGS. 2 and 3, which are schematic representations of an exemplary method 200 and of exemplary usage information 300, respectively, both according to exemplary embodiments of the present invention.

Fluid (e.g., water) may be received into the fluid input 102, flow through the fluid channel 106, and out through the fluid output 104. In operation 202, a flow amount of the water may be captured from the fluid measuring unit 108 as the water passes through the fluid channel 106. Stated differently, the flow amount of the water may be metered by the fluid measuring unit 108. For example, a flow amount of the water (e.g., a gallon) during a time period (e.g., one minute) may be obtained by the fluid measuring unit 108.

In operation 204, the flow amount of the water may be processed by the controller 114 into fluid usage information. In operation 206, the fluid usage information may be stored in the memory 116. For example, an exemplary usage pattern over a multiple time periods is captured in the exemplary usage information 300 of FIG. 3. During a first time period, 302, a flow amount of water (0 gallons) during the first time period (00:00 to 00:01) may be processed into the fluid usage information (a total flow amount of 0 gallons) and stored.

In operation 208, the monitoring unit 120 may monitor the fluid usage information in the memory 116 and thereafter determine whether a predetermined condition has been met (operation 210). It should be appreciated that operations 208 and 210 may occur simultaneous to or parallel to operation 204. Alternatively, operation 208 and 210 may occur periodically (e.g., after every predetermined time period 302 through 314, or after a certain number of predetermined time periods). The predetermined condition that is checked may be whether the total flow amount has changed by a predetermined threshold amount (e.g., at least one gallon). The predetermined condition may be set by a utility company.

Turning back to the exemplary usage pattern captured in the fluid usage information 300 of FIG. 3, the monitoring unit 120 may monitor the fluid usage information for the first time period 302 (e.g., the total flow amount of 0) and determine that the total flow amount has not changed by at least one gallon. That is, in operation 210, it may be determined that the fluid usage information does not meet the predetermined condition. Thereafter, the method 200 may return to operation 202 and an additional flow amount of water may be captured from the fluid measuring unit 108 as the water passes through the fluid channel 106. That additional flow amount of water may be processed into fluid usage information in operation 204 which may be stored in the memory 116. In operations 208 and 210, the monitoring unit may monitor the fluid usage information in the memory and again it may be determined whether the predetermined condition has been met.

For example, during a second time period 304, a flow amount of water (0 gallons) during the second time period (00:01 to 00:02) may be processed into the fluid usage information (a total flow amount of 0 gallons) and stored. As can be observed in FIG. 3, the total flow amount may be a cumulative measure of flow through the metering device 100. In other words, the total flow amount may serve as a flow meter. In this case, the total flow amount remains zero. The monitoring unit 120 may monitor the fluid usage information (e.g., the total flow amount of 0) and determine that the total flow amount has not changed by at least one gallon. That is, in operation 210, it may be determined that the fluid usage information does not meet the predetermined condition. Thereafter, the method 200 may return to operation 202 and an additional flow amount of water may be captured from the fluid measuring unit 108 as the water passes through the fluid channel 106. That additional flow amount of water may be processed into fluid usage information in operation 204 which may be stored in the memory 116. In operations 208 and 210, the monitoring unit may monitor the fluid usage information in the memory and again it may be determined whether the predetermined condition has been met.

During a third time period 306, a flow amount of water (1 gallon) during the third time period 306 (00:02 to 00:03) may be processed into the fluid usage information (a total flow amount of 1 gallon) and stored. The monitoring unit 120 may monitor the fluid usage information (e.g., the total flow amount of 1 gallon) and determine that the total flow amount has changed by at least one gallon. That is, in operation 210, it may be determined that the fluid usage information does meet the predetermined condition and the method may proceed to operation 212.

In operation 212, the controller 114 may power up the wireless communications unit 118 which may then transmit the fluid usage information (operation 214). In an embedment, an acknowledgement may be received by the wireless communications unit that the transmitted fluid usage information was received). After the fluid usage information is transmitted (and, in an embodiment, after acknowledgement is received), the controller may cause the wireless communications unit 118 to power down. Thereafter, the method 200 may return to operation 202 and an additional flow amount of water may be captured from the fluid measuring unit 108 as the water passes through the fluid channel 106. That additional flow amount of water may be processed into fluid usage information in operation 204 which may be stored in the memory 116. In operations 208 and 210, the monitoring unit may monitor the fluid usage information in the memory and again it may be determined whether the predetermined condition has been met.

Turning back to the exemplary usage pattern captured in the fluid usage information 300 of FIG. 3, a flow amount of water (0 gallons) during the fourth time period 308 may be processed into the fluid usage information (a total flow amount of 1 gallon) and stored. Ultimately, the method 200 may return to operation 202 because the predetermined condition will be determined not to have been met during operation 210. However, during the fifth time period 310 and sixth time period 312, flow amounts of 1 gallon for each time period may be processed into the fluid usage information (total flow amounts of 2 and 3 gallons, respectively). For each of these time periods, the method 200 may proceed to operations 212 and 214 because in each time period, the predetermined condition will be determined to have been met during operation 210. Finally, during the seventh time period 314, a flow amount of water (0 gallons) may be processed into the fluid usage information (a total flow amount of 3 gallons) and stored. Ultimately, the method 200 may return to operation 202 because the predetermined condition will be determined not to have been met during operation 210 for this seventh time period 314.

As noted above, the above discussed method 200 and fluid usage information 300 are only exemplary. Additional and/or different operations and data may be included in methods and fluid usage information in accordance with the present embodiments. Further, the consistent depiction of a flow rate of one gallon per minute is only for purposes of brevity in explanation. The present embodiments are equally applicable to a variable flow rate in addition to various constant flow rates.

Embodiments of the present invention may provide benefits such as extended fluid meter battery life. For example, according to an embodiment, a fluid meter battery life may be extended to twenty years (20) years or more. Additionally, embodiments of the present invention may provide improved timelines and accuracy of fluid usage information. For example, according to an embodiment, real time or near real time fluid usage information may be transmitted to a utility or available to a consumer. Further, according to an embodiment, by receiving an acknowledgement that the fluid information was in fact received, accuracy of usage information may be improved.

Embodiments of the present invention have been disclosed herein as extended fluid meter battery life apparatus and methods. The apparatus and methods may take the form of hardware and software, software, or hardware. Furthermore, the apparatus and methods may be embodied in whole or in part as a computer program on a computer-readable storage medium having computer-readable program instructions embodied in the storage medium. Any suitable computer-readable storage medium may be utilized including non-volatile flash memory, and/or magnetic storage devices. The computer-readable program instructions may be executed by a computer including one or more processors and a memory. For example, the above-described controller 114 may be embodied as instructions executed by the one or more processors.

Although embodiments of the present invention have been shown and described, it would be appreciated by those skilled in the art that changes may be made in these embodiments without departing from the principles and spirit of the invention. For example, although a fluid metering device 100 is shown in FIG. 1 as having a single controller 114 along with components such as the fluid flow measuring unit 108 and the wireless communications unit 118, multiple controllers may be present within or separate from each of multiple components. As another example, although FIG. 1 shows the monitoring unit 120 as a separate component from the controller 114, a monitoring unit may be provided as part of a controller. Accordingly, the embodiments should not be read as limiting the invention. Rather, the invention is defined in the claims and their equivalents.

1. A fluid metering device, comprising:
a battery;
a wireless communications unit powered by the battery; and
a monitoring unit configured to monitor fluid usage information to determine whether the fluid usage information meets a predetermined condition,
wherein the wireless communications unit is powered up if the fluid usage information meets the predetermined condition and the fluid usage information is transmitted using the wireless communications unit.

2. The fluid metering device of claim 1, wherein the wireless communications unit is powered down after the transmitting of the fluid usage information.

3. The fluid metering device of claim 2, wherein the wireless communications unit is powered down after the transmitting of the fluid usage information after receipt of an acknowledgement of receipt of the transmitted fluid usage information.

4. The fluid metering device of claim 1, wherein the predetermined condition is whether a change in fluid usage information meets or exceeds a predetermined threshold.

5. The fluid metering device of claim 1, further comprising:
a fluid input;
a fluid output;
a fluid channel between the fluid input and the fluid output; and
a flow measuring unit configured to measure a flow amount of fluid passing through the fluid channel,
wherein the fluid usage information may be processed from the flow amount of fluid.

6. The fluid metering device of claim 5, further comprising:
a memory; and
a controller,
wherein the controller is configured to process the flow amount of fluid into the fluid usage information, and wherein the fluid usage information may be stored in the memory.

7. The fluid metering device of claim 1, wherein the wireless communications unit is a ZigBee communications unit.

8. The fluid metering device of claim 1, wherein the battery is a lithium battery.

9. The fluid metering device of claim 1, wherein the monitoring is periodic.

10. A fluid metering method, comprising:
monitoring, using a monitoring unit, fluid usage information to determine whether the fluid usage information meets a predetermined condition; and
powering up a wireless communications unit powered by a battery if the fluid usage information meets the predetermined condition, and transmitting the fluid usage information using the wireless communications unit.

11. The fluid meting method of claim 10, further comprising powering down the wireless communications unit after the transmitting of the fluid usage information.

12. The fluid metering method of claim 11, further comprising receiving an acknowledgement of receipt of the transmitted fluid usage information before said powering down of the wireless communications unit.

13. The fluid metering method of claim 10, wherein the predetermined condition is whether a change in fluid usage information meets or exceeds a predetermined threshold.

14. The fluid metering method of claim 10, further comprising:
receiving fluid in a fluid input, through a fluid channel, and out through a fluid output; and
measuring, using a flow measuring unit, a flow amount of the fluid passing through the fluid channel, wherein the fluid usage information is processed from the flow amount of fluid.

15. The fluid metering method of claim 14, further comprising:
processing, using a processor, the flow amount of fluid into the fluid usage information; and
storing the fluid usage information in a memory.

16. The fluid metering method of claim 10, wherein the wireless communications unit is a ZigBee communications unit.

17. The fluid metering method of claim 10, wherein the battery is a lithium battery.

18. The fluid metering method of claim 10, wherein the metering is periodic.

19. A fluid metering device, comprising:
a fluid input;
a fluid output;
a fluid channel between the fluid input and the fluid output;
a flow measuring unit configured to measure a flow amount of fluid passing through the fluid channel;
a battery;
a wireless communications unit powered by the battery; and
a monitoring unit configured to monitor the flow amount of fluid to determine whether the flow amount of fluid meets or exceeds a predetermined threshold,
wherein the wireless communications unit is powered up if the flow amount of fluid meets or exceeds the predetermined threshold and the flow amount of fluid or fluid usage information is transmitted using the wireless communications unit.

20. The fluid metering device of claim 19, further comprising:
a memory; and
a controller,
wherein the controller is configured to process the flow amount of fluid into the fluid usage information, and wherein the fluid usage information may be stored in the memory.
